(19) United States
(12) Patent Application Publication
(10) Pub. No.: US 2026/0303766 A1
(43) Pub. Date: Oct. 1, 2026

(54) PROJECTION METHOD, PROJECTION SYSTEM, AND NON-TRANSITORY COMPUTER-READABLE STORAGE MEDIUM STORING PROGRAM

(71) Applicant: SEIKO EPSON CORPORATION, Tokyo (JP)

(72) Inventor: Takumi OIKE, Matsumoto-shi (JP)

(73) Assignee: SEIKO EPSON CORPORATION, Tokyo (JP)

(21) Appl. No.: 19/629,403

(22) Filed: Mar. 26, 2026

(30) Foreign Application Priority Data
Mar. 27, 2025 (JP) 2025-052890

(51) Int. Cl. H04N 9/31

(52) U.S. Cl. CPC H04N 9/3194; H04N 9/3182

(57) ABSTRACT

According to an aspect of the present disclosure, there is provided a projection method including measuring, with a first sensor, a reflection characteristic of reflected light from a first display surface, generating a plurality of first correction values based on the reflection characteristic, generating first corrected image data by performing color correction for input image data based on the plurality of first correction values, projecting a first corrected image based on the first corrected image data onto the first display surface, when detecting a change in the first display surface with a second sensor, generating second corrected image data by performing the color correction for the input image data based on a plurality of second correction values obtained by changing at least a part of the plurality of first correction values to correction values for returning a color of a plurality of points in an image projected onto the first display surface to or bringing the color of the plurality of points to a color of the image projected onto the first display surface without performing the color correction, and projecting a second corrected image based on the second corrected image data onto the first display surface.

The present application is based on, and claims priority from JP Application Serial Number 2025-052890, filed Mar. 27, 2025, the disclosure of which is hereby incorporated by reference herein in its entirety.

### BACKGROUND

### 1. Technical Field

The present disclosure relates to a projection method, a projection system, and a non-transitory computer-readable storage medium storing a program.

### 2. Related Art

JP-A-2005-236528 discloses a projector that performs color correction for image data based on a color correction table. In the projector, the color correction table is generated based on a reflection characteristic of a color component on a reference projection surface of a projected image and a reflection characteristic of a color component on a predetermined projection surface of image data projected immediately after a light source of the projector is turned on.

JP-A-2005-236528 is an example of the related art.

With the technique described in JP-A-2005-236528, it is possible to project, onto the predetermined projection surface having a color or a surface state different from that of the reference projection surface, a clear image having a color close to that of the image projected onto the reference projection surface. However, when a relative positional relationship between a projected corrected image and the predetermined projection surface changes because the projector or the predetermined projection surface moves after the color correction table is generated, it is likely that image quality after the color correction deteriorates more than image quality before the color correction.

### SUMMARY

According to an aspect of the present disclosure, there is provided a projection method including: measuring, with a first sensor, a reflection characteristic of a color component of reflected light from a first display surface having a first color; generating, based on the reflection characteristic, a plurality of first correction values that are a plurality of correction values for bringing a color of a plurality of points in an image projected onto the first display surface to a color in a case in which the image is projected onto a second display surface having a second color; generating first corrected image data by performing color correction for input image data based on the plurality of first correction values; projecting a first corrected image based on the first corrected image data onto the first display surface; when detecting a change in the first display surface with a second sensor, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface without performing the color correction; and projecting a second corrected image based on the second corrected image data onto the first display surface.

According to an aspect of the present disclosure, there is provided a projection system including: a first sensor configured to measure a reflection characteristic of a color component of reflected light from a first display surface having a first color; a second sensor configured to detect a change in the first display surface; a projector configured to project an image onto the first display surface; and one or a plurality of processors configured to control the projector, wherein the one or the plurality of processors execute: measuring, with the first sensor, the reflection characteristic of the color component of the reflected light from the first display surface; generating, based on the reflection characteristic, a plurality of first correction values that are a plurality of correction values for bringing a color of a plurality of points in the image projected onto the first display surface to a color in a case in which the image is projected onto a second display surface having a second color; generating first corrected image data by performing color correction for input image data based on the plurality of first correction values; projecting a first corrected image based on the first corrected image data onto the first display surface; when detecting the change in the first display surface with the second sensor, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface without performing the color correction; and projecting a second corrected image based on the second corrected image data onto the first display surface.

According to an aspect of the present disclosure, there is provided a non-transitory computer-readable storage medium storing a program for causing a computer to execute: measuring, with a first sensor, a reflection characteristic of a color component of reflected light from a first display surface having a first color; generating, based on the reflection characteristic, a plurality of first correction values that are a plurality of correction values for bringing a color of a plurality of points in an image projected onto the first display surface to a color in a case in which the image is projected onto a second display surface having a second color; generating first corrected image data by performing color correction for input image data based on the plurality of first correction values; projecting a first corrected image based on the first corrected image data onto the first display surface; when detecting a change in the first display surface with a second sensor, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface without performing the color correction; and projecting a second corrected image based on the second corrected image data onto the first display surface.

### BRIEF DESCRIPTION OF THE DRAWINGS

FIG. 1 is a block diagram schematically illustrating a configuration of a projection system in an embodiment.

FIG. 2 is a flowchart illustrating color correction processing executed by a processor.

FIG. 3 is a diagram illustrating an example of a state in which an input image based on input image data is projected onto a first display surface.

FIG. 4 is a diagram illustrating an example of a state in which a first corrected image based on first corrected image data is projected onto the first display surface.

FIG. 5 is a diagram illustrating an example of a state in which the quality of the first corrected image deteriorates when a relative positional relationship between the projected first corrected image and the first display surface changes.

FIG. 6 is a diagram illustrating an example of a state in which a second corrected image based on second corrected image data is projected onto the first display surface instead of the first corrected image.

### DESCRIPTION OF EMBODIMENTS

An embodiment of the present disclosure is explained below with reference to the drawings. In the drawings referred to below, scales of members are sometimes differentiated from actual scales in order to illustrate the members in recognizable sizes.

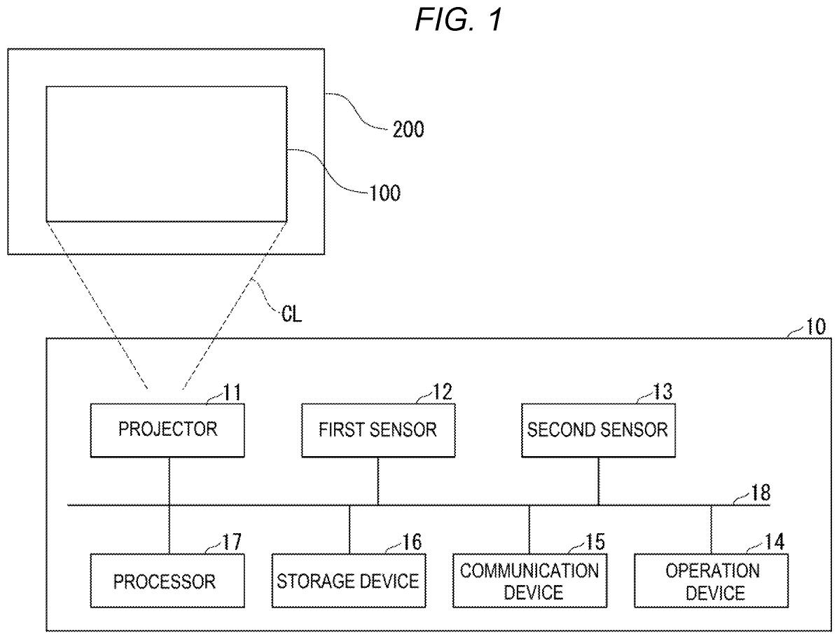

FIG. 1 is a block diagram schematically illustrating a configuration of a projection system 10 in the present embodiment. As illustrated in FIG. 1, the projection system 10 includes a projector 11, a first sensor 12, a second sensor 13, an operation device 14, a communication device 15, a storage device 16, a processor 17, and a communication bus 18.

The projector 11 projects an image 100 onto a first display surface 200. The projector 11 in the present embodiment is a three-panel projector in which three liquid crystal panels are used as light modulation devices. The liquid crystal panel used as the light modulation device may be a transmissive type or a reflective type. The number of liquid crystal panels is not limited to three and may be one. The light modulation device is not limited to the liquid crystal panel and may be a digital micromirror device (DMD). Since the three-plate projector used in the present embodiment is generally known, a configuration of the projector 11 is briefly explained below.

For example, the projector 11 includes a light source that emits white light, a light separation element that separates the white light emitted from the light source into red light, green light, and blue light, a first liquid crystal panel that modulates the red light, a second liquid crystal panel that modulates the green light, and a third liquid crystal panel that modulates the blue light. The projector 11 further includes a liquid crystal control circuit that controls the transmittance of pixels provided in each of the three liquid crystal panels, a light combining element that combines the color image lights emitted from the three liquid crystal panels, and a projection optical element that enlarges and projects combined image light CL emitted from the light combining element.

The combined image light CL is projected onto the first display surface 200, whereby the image 100 is displayed on the first display surface 200. In the present embodiment, the projector 11 projecting the combined image light CL onto the first display surface 200 is synonymous with the projector 11 projecting the image 100 onto the first display surface 200. The liquid crystal control circuit is coupled to the processor 17 via the communication bus 18 and controls, based on image data supplied from the processor 17 at a predetermined frame rate, the transmittance of the pixels provided in each of the three liquid crystal panels. Accordingly, the image 100 based on the image data supplied from the processor 17 is projected from the projector 11.

The projector 11 is not limited to be the three-panel projector and may be a single-panel projector in which one liquid crystal panel is used as a light modulation device. The projector 11 may be a projector of a type in which a device other than the liquid crystal panel is used as the light modulation device.

The first sensor 12 receives reflected light from the first display surface 200 and measures a reflection characteristic of a color component of the received reflected light. For example, the first sensor 12 measures tristimulus values of the reflected light as the reflection characteristic of the color component of the reflected light. The first sensor 12 is coupled to the processor 17 via the communication bus 18, measures the tristimulus values of the received reflected light according to an instruction of the processor 17, and outputs an electric signal indicating a measurement result of the tristimulus values to the processor 17. For example, the first sensor 12 is a charge coupled device (CCD) sensor.

The second sensor 13 detects a change in the first display surface 200. For example, the second sensor 13 detects, as the change in the first display surface 200, a change in a relative positional relationship between the image 100 projected onto the first display surface 200 and the first display surface 200. The second sensor 13 is coupled to the processor 17 via the communication bus 18 and outputs, to the processor 17, an electric signal indicating that the change in the first display surface 200 has been detected. In the present embodiment, the second sensor 13 is a sensor different from the first sensor 12. For example, the second sensor 13 is a distance sensor, an acceleration sensor, an illuminance sensor, or the like. However, one sensor may serve as the first sensor 12 and the second sensor 13. The first sensor 12 and the second sensor 13 may be sensors of the same type.

The operation device 14 is a device that receives operation by a user. The operation device 14 includes a plurality of operation keys. For example, the operation keys include a power key, a menu call key, a direction key, and an enter key. The operation keys may be hardware keys or software keys displayed on a touch panel. The operation device 14 is coupled to the processor 17 via the communication bus 18 and outputs an electric signal generated when the operation keys are operated by the user to the processor 17 as an operation signal.

The operation device 14 may include a photoelectric conversion circuit that receives infrared light transmitted from a remote controller (not illustrated) of the projector 11 and converts the infrared light into an electric signal. The photoelectric conversion circuit outputs the electric signal obtained from the infrared light to the processor 17 as a remote operation signal. The remote controller converts an electrical signal generated when operation keys provided on the remote controller are operated by the user into infrared light and transmits the infrared light to the projector 11. That is, the remote operation signal output from the photoelectric conversion circuit of the operation device 14 is substantially the same as the electrical signal generated when the operation keys of the remote controller are operated by the user.

The communication device 15 performs wired communication or wireless communication with an external device (not illustrated). Examples of the external device include a personal computer, a digital versatile disc (DVD) player, a tablet terminal, and an Internet server. The communication device 15 is coupled to the processor 17 via the communication bus 18, transmits a signal received from the processor 17 to the external device, and outputs a signal received from the external device to the processor 17.

The storage device 16 includes a nonvolatile memory that stores programs, various setting data, and the like necessary for causing the processor 17 to execute various kinds of processing and a volatile memory used as a temporary data saving destination when the processor 17 executes various kinds of processing. The storage device 16 is coupled to the processor 17 via the communication bus 18, stores data according to a write instruction signal received from the processor 17, and outputs designated data among the stored data to the processor 17 according to a read instruction signal received from the processor 17.

The processor 17 controls an overall operation of the projection system 10 according to the programs stored in the storage device 16. For example, the processor 17 includes one or a plurality of processors such as a central processing unit (CPU). Some or all of functions of the processor 17 may be implemented by a circuit such as a digital signal processor (DSP), an application specific integrated circuit (ASIC), a programmable logic device (PLD), or a field programmable gate array (FPGA). The processor 17 executes various kinds of processing in parallel or sequentially. The processor 17 is an example of a computer. The computer may be provided in an external device coupled to the projection system 10.

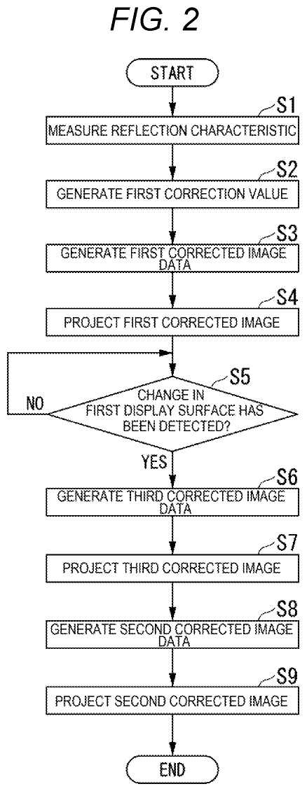

Hereinafter, color correction processing executed by the processor 17 according to a program stored in advance in the storage device 16 is explained. FIG. 2 is a flowchart illustrating the color correction processing executed by the processor 17. The processor 17 executes the color correction processing illustrated in FIG. 2 by reading the program from the storage device 16 and executing the program.

As illustrated in FIG. 2, after starting the color correction processing, first, the processor 17 executes measuring, with the first sensor 12, a reflection characteristic of a color component of reflected light from the first display surface 200 having a first color (step S1). The first color of the first display surface 200 is, for example, red. Of regions included in the first display surface 200, a first region 210 in the left half is a region having the first color.

In the present embodiment, as a method of measuring the reflection characteristic of the color component of the reflected light from the first display surface 200, a method described in JP-A-2005-236528 is adopted. However, the measurement method is not limited thereto because the reflection characteristic of the color component of the reflected light from first display surface 200 only has to be able to be measured. For details of the measurement method, refer to JP-A-2005-236528. However, briefly explaining the present embodiment, first, the processor 17 causes the projector 11 to project a logo image as the image 100 with white light. Logo image data, which is image data indicating the logo image, is stored in advance in the storage device 16. The processor 17 reads the logo image data from the storage device 16 and outputs the read logo image data to the liquid crystal control circuit of the projector 11. The liquid crystal control circuit controls, based on the logo image data, the transmittance of the pixels provided in each of the three liquid crystal panels. Accordingly, the logo image is projected from the projector 11 onto the first display surface 200 as the image 100.

After causing the projector 11 to project the logo image, the processor 17 instructs the first sensor 12 to measure a reflection characteristic. According to an instruction from the processor 17, the first sensor 12 receives reflected light from the first display surface 200 onto which the logo image is projected, measures tristimulus values of the received reflected light, and outputs an electric signal indicating a measurement result of the tristimulus values to the processor 17. The processor 17 acquires, based on the output signal of the first sensor 12, the measurement result of the tristimulus values as a measurement result of the reflection characteristic.

Subsequently, the processor 17 executes generating, based on the acquired reflection characteristic, a plurality of first correction values, which are a plurality of correction values for bringing a color of a plurality of points in the logo image projected onto the first display surface 200 close to a color in the case in which the logo image is projected onto a second display surface having a second color (step S2). In the present embodiment, each of the plurality of points represents each of a plurality of pixels of the liquid crystal panel. Not only this, but one point may include a plurality of pixels, for example, four pixels or nine pixels, in a range in which the user does not feel uncomfortable in a color-corrected image. One point may be one of regions in a captured image divided by edge detection or the like.

In the present embodiment, as a method of generating the first correction value based on the acquired reflection characteristic, that is, the tristimulus values of the reflected light, a method described in JP-A-2005-236528 is adopted. However, the method of generating the correction value is not limited thereto because the first correction value only has to be able to be generated. For details of the method of generating the correction value, refer to JP-A-2005-236528. However, briefly explaining the present embodiment, first, the projector 11 is started in a dark room before the projector 11 is used and images of colors of R (red), G (green), B (blue), and bk (black) are projected on the second display surface. A reflection characteristic of reflected light on the second display surface of an output of the projector 11 is measured by the first sensor 12, an output voltage value of the first sensor 12 is converted into tristimulus values, and a matrix indicating a correspondence relationship between the output voltage value of the first sensor 12 and the tristimulus values is generated and stored in the storage device 16. Then, based on the generated matrix, a reference correction value that is a correction value serving as a reference is generated. The reference correction value is also stored in the storage device 16. The second color, which is the color of the second display surface, is, for example, white.

The processor 17 converts, based on the matrix stored in the storage device 16 in advance as explained above, an output voltage value output from the first sensor 12 when causing the projector 11 to project the logo image into tristimulus values. Then, the processor 17 generates, based on the reference correction value stored in advance in the storage device 16 as explained above and the tristimulus values of the reflected light of the logo image, a plurality of first correction values, which are a plurality of correction values corresponding one-to-one to a plurality of points for bringing a color of the plurality of points in the logo image projected onto the first display surface 200 having the first color close to a color in the case in which the logo image is projected onto the second display surface having the second color.

Subsequently, the processor 17 executes performing color correction for input image data based on the plurality of first correction values to thereby generate first corrected image data (step S3). Here, the input image data is image data received by the processor 17 from the external device via the communication device 15.

Subsequently, the processor 17 executes projecting a first corrected image based on the first corrected image data onto the first display surface 200 (step S4). Specifically, the processor 17 outputs the first corrected image data to the liquid crystal control circuit of the projector 11. The liquid crystal control circuit controls, based on the first corrected image data, the transmittance of the pixels provided in each of the three liquid crystal panels. Accordingly, the first corrected image is projected from the projector 11 onto the first display surface 200 as the image 100.

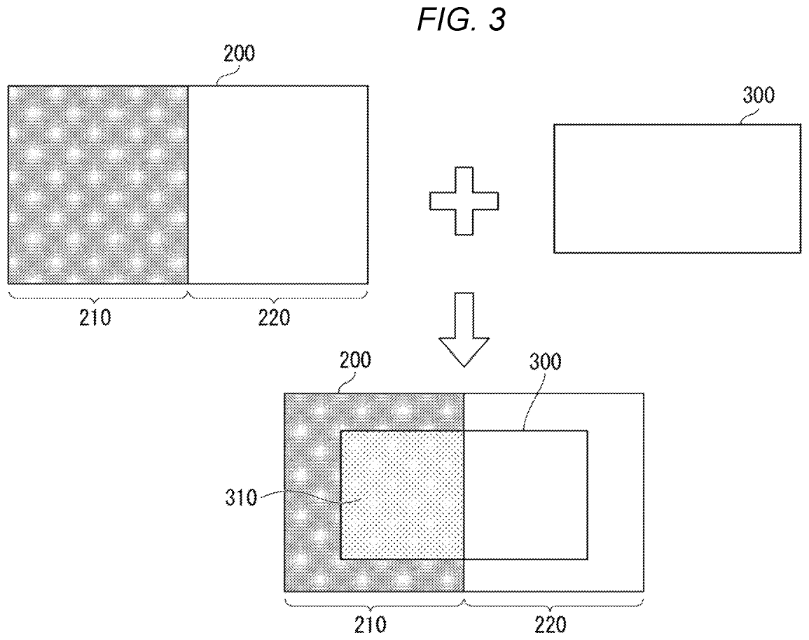

FIG. 3 is a diagram illustrating an example of a state in which an input image 300 based on input image data is projected onto the first display surface 200 without performing color correction based on the first correction value on the input image data. For example, the input image 300 is a white image. For example, of the regions included in the first display surface 200, the first region 210 in the left half is a red region and a second region 220 in the right half is a white region.

When the white input image 300 is projected onto the first display surface 200 including the first region 210 and the second region 220 explained above, a color of a region 310 overlapping the first region 210 of regions included in the input image 300 changes to a mixed color of red and white.

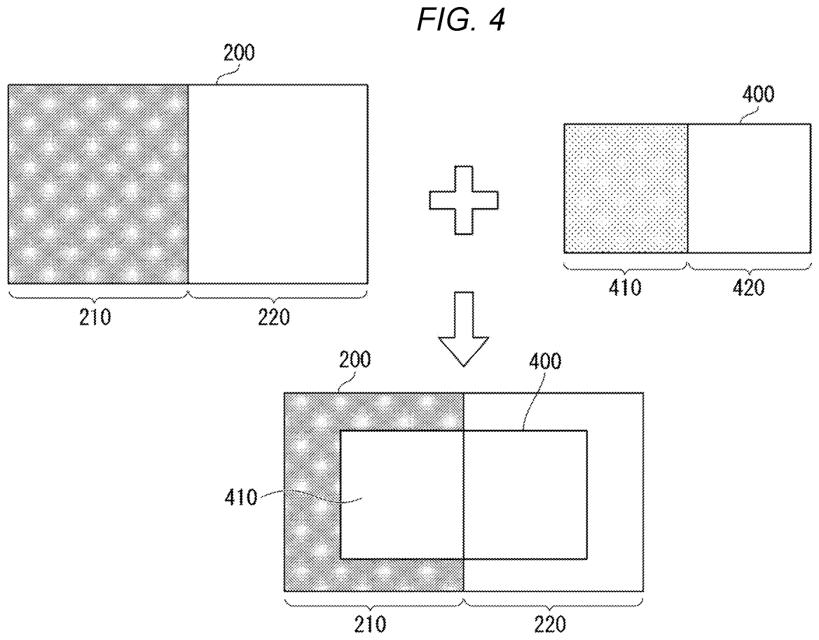

FIG. 4 is a diagram illustrating an example of a state in which the first corrected image data is generated by performing the color correction based on the first correction value on the input image data and a first corrected image 400 based on the first corrected image data is projected onto the first display surface 200. As in FIG. 3, of the regions included in the first display surface 200, the first region 210 in the left half is a red region and the second region 220 in the right half is a white region. A color of a region 410 overlapping the first region 210 of regions included in the first corrected image 400 is a color that brings red close to white, that is, cyan, which is a mixed color of blue and green. A color of a region 420 other than the region 410 overlapping the first region 210 of the regions included in the first corrected image 400 is white.

When the first corrected image 400 is projected onto the first display surface 200 including the first region 210 and the second region 220 explained above, the color of the region 410 overlapping the first region 210 of the regions included in the first corrected image 400 changes to substantially white. As explained above, by performing the color correction based on the first correction value on the input image data to generate the first corrected image data and projecting the first corrected image 400 based on the first corrected image data onto the first display surface 200, the first corrected image 400, which is an image having the same color as the input image 300, can be displayed on the first display surface 200.

However, when a relative positional relationship between the projected first corrected image 400 and the first display surface 200 is changed because the projector 11 or the first display surface 200 moves after the first correction value is generated, the quality of the first corrected image 400 after the color correction sometimes deteriorates more than the quality of the input image 300 before the color correction.

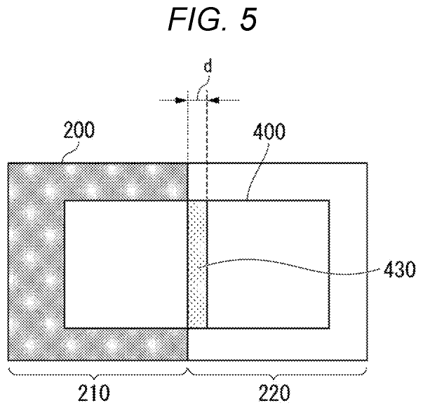

FIG. 5 is a diagram illustrating an example in which the quality of the first corrected image 400 deteriorates when the relative positional relationship between the projected first corrected image 400 and the first display surface 200 changes. FIG. 5 exemplifies a case in which the projector 11 or the first display surface 200 moves in the lateral direction by a distance d after the first correction value is generated. As illustrated in FIG. 5, when the projector 11 or the first display surface 200 moves in the lateral direction by the distance d after the first correction value is generated, a band-shaped region 430 having a cyan color appears on the inside of the first corrected image 400 projected onto the first display surface 200.

In the present embodiment, in order to suppress the deterioration in the image quality explained above that occurs when the relative positional relationship between the projected first corrected image 400 and the first display surface 200 changes, the processor 17 executes processing explained below. The explanation is continued by referring back to FIG. 2 below.

As illustrated in FIG. 2, after executing the projecting the first corrected image based on the first corrected image data onto the first display surface 200, the processor 17 determines whether a change in the first display surface 200 is detected by the second sensor 13 (step S5). For example, the processor 17 determines, based on an output signal of the distance sensor that is the second sensor 13, whether a change in the relative positional relationship between the projected first corrected image 400 and the first display surface 200 is detected as the change in the first display surface 200. As another example, when the acceleration sensor is used as the second sensor 13, an inclination of the projector is detected as the change in the first display surface 200. When the illuminance sensor is used as the second sensor 13, the first display surface 200 being irradiated with natural light, for example, the sunlight, is detected as the change in the first display surface 200. When the CCD sensor is used as the second sensor 13, a change in the color of the first display surface 200 is detected as the change in the first display surface 200. For example, the change in the color of first display surface 200 is a change in an image displayed by the liquid crystal display that is the first display surface 200.

When the change in the first display surface 200 is not detected by the second sensor 13 (step S5: NO), the processor 17 repeats the processing in step S5 at constant time intervals while keeping causing the projector 11 to project the first corrected image 400 onto the first display surface 200.

On the other hand, when the change in the first display surface 200 is detected by the second sensor 13 (step S5: YES), the processor 17 executes generating second corrected image data by performing the color correction for the input image data based on a plurality of second correction values obtained by changing at least a part of the plurality of first correction values to correction values for returning the color of the image projected onto the first display surface 200 to or bringing the color of the image projected onto the first display surface 200 to a color of the image projected onto the first display surface 200 without performing the color correction (step S8).

For example, correction values included in the plurality of second correction values for returning the color of the image projected onto the first display surface 200 to the color of the image projected onto the first display surface 200 without performing the color correction are zero. Alternatively, for example, the correction values included in the plurality of second correction values for bringing the color of the image projected onto the first display surface 200 to the color of the image projected onto the first display surface 200 without performing the color correction are an average value of the plurality of first correction values. These correction values are correction data set in advance before the color correction. Specifically, the plurality of second correction values are set in advance before the color correction or a method of calculating the plurality of second correction values based on the plurality of first correction values is set in advance before the color correction.

Then, the processor 17 executes projecting the second corrected image based on the second corrected image data onto the first display surface 200 (step S9). Specifically, the processor 17 outputs the second corrected image data to the liquid crystal control circuit of the projector 11. The liquid crystal control circuit controls, based on the second corrected image data, the transmittance of the pixels provided in each of the three liquid crystal panels. Accordingly, the second corrected image is projected from the projector 11 onto the first display surface 200 as the image 100. In other words, when the first display surface 200 changes, the processor 17 switches the image projected onto the first display surface 200 from the first corrected image on which the color correction is performed to the second corrected image whose color is returned to or brought close to a color of the image projected in at least a part of a region without performing the color correction.

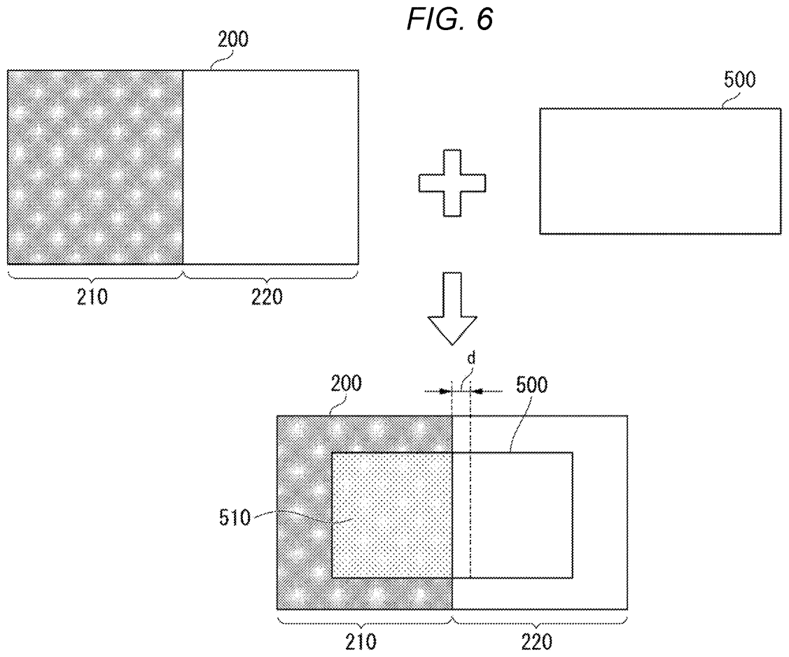

FIG. 6 is a diagram illustrating an example of a state in which a second corrected image 500 based on the second corrected image data is projected onto the first display surface 200 instead of the first corrected image 400 when the relative positional relationship between the projected first corrected image 400 and the first display surface 200 changes. As in FIG. 3, of the regions included in the first display surface 200, the first region 210 in the left half is a red region and the second region 220 in the right half is a white region.

FIG. 6 illustrates a case in which the projector 11 or the first display surface 200 moves in the lateral direction by the distance d. For example, FIG. 6 illustrates a state in which the second corrected image 500 based on the second corrected image data generated when the correction values included in the plurality of second correction values are zero is projected onto the first display surface 200.

In this case, color correction is not performed on input image data. Therefore, as illustrated in FIG. 6, the second corrected image 500 that is the same as the white input image 300 is projected onto the first display surface 200 including the first region 210 and the second region 220. In this case, a color of a region 510 overlapping the first region 210 of regions included in the projected second corrected image 500 is a mixed color of red and white. However, the band-shaped region 430 having the cyan color illustrated in FIG. 5 disappears.

As explained above, when the processor 17 detects the change in the first display surface 200 with the second sensor 13, by executing the processing in steps S8 and S9, even if the relative positional relationship between the projected first corrected image 400 and the first display surface 200 changes, it is possible to prevent the quality of the second corrected image 500 projected onto the first display surface 200 instead of the first corrected image 400 from deteriorating more than the quality of the first corrected image 400.

The explanation is continued by referring back to FIG. 2 below.

As illustrated in FIG. 2, before projecting the second corrected image 500 onto the first display surface 200, the processor 17 executes generating third corrected image data by performing color correction for the input image data based on a plurality of third correction values obtained by changing at least a part of the plurality of first correction values to correction values for bringing the color of the image projected onto the first display surface 200 close to the color of the image projected onto the first display surface 200 without performing the color correction (step S6).

The processor 17 executes projecting a third corrected image based on the third corrected image data onto the first display surface 200 before projecting the second corrected image 500 onto the first display surface 200 and after generating the third corrected image data (step S7). Here, the second corrected image 500 includes a portion whose color is close to the color of the image projected onto the first display surface 200 without performing the color correction than the third corrected image.

As explained above, by projecting the third corrected image based on the third corrected image data onto the first display surface 200 before projecting the second corrected image 500 onto the first display surface 200, a tint of the image projected onto the first display surface 200 changes stepwise. Therefore, the user is less likely to feel uncomfortable for the change in the tint when a projected image is switched.

The color correction processing executed by the processor 17 according to the program stored in the storage device 16 is as explained above. The projection method in the present embodiment is implemented by the processor 17 executing the color correction processing.

That is, the projection method of the present embodiment includes measuring, with the first sensor 12, a reflection characteristic of a color component of reflected light from the first display surface 200 having a first color, generating, based on the reflection characteristic, a plurality of first correction values that are a plurality of correction values for bringing a color of a plurality of points in an image projected onto the first display surface 200 to a color in the case in which the image is projected onto a second display surface having a second color, generating first corrected image data by performing color correction for input image data based on the plurality of first correction values, projecting the first corrected image 400 based on the first corrected image data onto the first display surface 200, when detecting a change in the first display surface 200 with the second sensor 13, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface 200 without performing the color correction, and projecting the second corrected image 500 based on the second corrected image data onto the first display surface 200.

As explained above, when the change in the first display surface 200 is detected by the second sensor 13 after the first corrected image 400 based on the first corrected image data is projected onto the first display surface 200, by generating the second corrected image data by performing the color correction for the input image data based on the plurality of second correction values obtained by changing at least a part of the plurality of first correction values to correction values for returning the color of the plurality of points to or bringing the color of the plurality of points to the color of the image projected onto the first display surface 200 without performing the color correction, and, by projecting the second corrected image 500 based on the second corrected image data onto the first display surface 200, even if a relative positional relationship between the first corrected image 400 displayed first and the first display surface 200 changes, it is possible to prevent the quality of the second corrected image 500 projected onto the first display surface 200 instead of the first corrected image 400 from deteriorating more than the quality of the first corrected image 400.

In the projection method in the present embodiment, the correction values included in the plurality of second correction values may be zero.

According to the present embodiment explained above, when the status of the first display surface 200 onto which the first corrected image 400 is projected changes, correction for which the user feels uncomfortable is eliminated.

In the projection method in the present embodiment, the correction values included in the plurality of second correction values may be an average value of the plurality of first correction values.

According to the present embodiment explained above, depending on a color of the first display surface 200, uncomfortable feeling of the user concerning a tint of the first display surface 200 is reduced more than reducing the correction values included in the plurality of second correction values to zero.

The projection method in the present embodiment further includes, before projecting the second corrected image 500 onto the first display surface 200, generating third corrected image data by performing the color correction for the input image data based on a plurality of third correction values obtained by changing at least a part of the plurality of first correction values to the correction values for bringing the color of the plurality of points close to the color of the image projected onto the first display surface 200 without performing the color correction, and projecting a third corrected image based on the third corrected image data onto the first display surface 200. The second corrected image 500 includes a portion closer to the color of the image projected onto the first display surface 200 without performing the color correction than the third corrected image.

According to the present embodiment explained above, by projecting the third corrected image based on the third corrected image data onto the first display surface 200 before projecting the second corrected image 500 onto the first display surface 200, a tint of the image projected onto the first display surface 200 changes stepwise. Therefore, the user is less likely to feel uncomfortable for a change in the tint when a projected image is switched.

In the present embodiment, the second sensor 13 may be a sensor different from the first sensor 12.

According to the present embodiment explained above, by disposing a sensor suitable for a change in the first display surface 200 desired be detected, it is possible to switch a correction value and a corrected image only in a specific situation and it is possible to suppress deterioration in the image quality of a projected image. For example, by using the acceleration sensor as the second sensor 13, it is possible to take measures such as not switching the correction value when it is successfully determined that the projector 11 or the first display surface 200 has returned to an original position because of light shaking or the like.

In the present embodiment, the second sensor 13 may be disposed on the first display surface 200.

According to the present embodiment explained above, without reacting to an object interrupting between the first display surface 200 and the projector 11, the correction value is changed only when the first display surface 200 itself changes. As a result, it is possible to reduce discomfort felt by the user because the correction value is frequently converted by the interrupting object.

The projection system 10 in the present embodiment includes the first sensor 12 that measures a reflection characteristic of a color component of reflected light from the first display surface 200 having a first color, the second sensor 13 that detects a change in the first display surface 200, the projector 11 that projects the image 100 onto the first display surface 200, and one or a plurality of the processors 17 that control the projector 11. The one or the plurality of processors 17 execute measuring, with the first sensor 12, the reflection characteristic of the color component of the reflected light from the first display surface 200, generating, based on the reflection characteristic, a plurality of first correction values that are a plurality of correction values for bringing a color of a plurality of points in the image projected onto the first display surface 200 to a color in a case in which the image is projected onto a second display surface having a second color, generating first corrected image data by performing color correction for input image data based on the plurality of first correction values, projecting the first corrected image 400 based on the first corrected image data onto the first display surface 200, when detecting the change in the first display surface 200 with the second sensor 13, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface 200 without performing the color correction, and projecting the second corrected image 500 based on the second corrected image data onto the first display surface 200.

With the projection system 10 in the present embodiment explained above, even when a relative positional relationship between the first corrected image 400 projected first and the first display surface 200 changes, it is possible to prevent the quality of the second corrected image 500 projected onto the first display surface 200 instead of the first corrected image 400 from deteriorating more than the quality of the first corrected image 400.

The program in the present embodiment causes a computer (the processor 17) to execute measuring, with the first sensor 12, a reflection characteristic of a color component of reflected light from the first display surface 200 having a first color, generating, based on the reflection characteristic, a plurality of first correction values that are a plurality of correction values for bringing a color of a plurality of points in an image projected onto the first display surface 200 to a color in the case in which the image is projected onto a second display surface having a second color, generating first corrected image data by performing color correction for input image data based on the plurality of first correction values, projecting the first corrected image 400 based on the first corrected image data onto the first display surface 200, when detecting a change in the first display surface 200 with the second sensor 13, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface 200 without performing the color correction, and projecting the second corrected image 500 based on the second corrected image data onto the first display surface 200.

With the program in the present embodiment explained above, even when a relative positional relationship between the first corrected image 400 projected first and the first display surface 200 changes, it is possible to prevent the quality of the second corrected image 500 projected onto the first display surface 200 instead of the first corrected image 400 from deteriorating more than the quality of the first corrected image 400.

Although the embodiment of the present disclosure is explained above, the technical scope of the present disclosure is not limited to the embodiment explained above, and various modifications can be made without departing from the gist of the present disclosure.

### SUMMARY OF PRESENT DISCLOSURE

A summary of the present disclosure is appended below.

(Appendix 1) A projection method including: measuring, with a first sensor, a reflection characteristic of a color component of reflected light from a first display surface having a first color; generating, based on the reflection characteristic, a plurality of first correction values that are a plurality of correction values for bringing a color of a plurality of points in an image projected onto the first display surface to a color in a case in which the image is projected onto a second display surface having a second color; generating first corrected image data by performing color correction for input image data based on the plurality of first correction values; projecting a first corrected image based on the first corrected image data onto the first display surface; when detecting a change in the first display surface with a second sensor, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface without performing the color correction; and projecting a second corrected image based on the second corrected image data onto the first display surface.

As in Appendix 1, when the change in the first display surface is detected by the second sensor after the first corrected image based on the first corrected image data is projected onto the first display surface, by generating the second corrected image data by performing the color correction for the input image data based on the plurality of second correction values obtained by changing at least a part of the plurality of first correction values to correction values for returning the color of the plurality of points to or bringing the color of the plurality of points to the color of the image projected onto the first display surface without performing the color correction, and, by projecting the second corrected image based on the second corrected image data onto the first display surface, even if a relative positional relationship between the first corrected image displayed first and the first display surface changes, it is possible to prevent the quality of the second corrected image projected onto the first display surface instead of the first corrected image from deteriorating more than the quality of the first corrected image.

(Appendix 2) The projection method described in Appendix 1, wherein the correction values included in the plurality of second correction values are zero.

According to Appendix 2, when the status of the first display surface onto which the first corrected image is projected changes, correction for which a user feels uncomfortable is eliminated.

(Appendix 3) The projection method described in Appendix 1, wherein the correction values included in the plurality of second correction values are an average value of the plurality of first correction values.

According to Appendix 3, depending on a color of the first display surface, uncomfortable feeling of a user concerning a tint of the first display surface is reduced more than reducing the correction values included in the plurality of second correction values to zero.

(Appendix 4) The projection method described in any one of Appendices 1 to 3, further including, before projecting the second corrected image onto the first display surface: generating third corrected image data by performing the color correction for the input image data based on the plurality of third correction values obtained by changing at least a part of the plurality of first correction values to the correction values for bringing the color of the plurality of points close to the color of the image projected onto the first display surface without performing the color correction; and projecting a third corrected image based on the third corrected image data onto the first display surface, wherein the second corrected image includes a portion closer to the color of the image projected onto the first display surface without performing the color correction than the third corrected image.

According to Appendix 4, by projecting the third corrected image based on the third corrected image data onto the first display surface before projecting the second corrected image onto the first display surface, a tint of the image projected onto the first display surface changes stepwise. Therefore, a user is less likely to feel uncomfortable for a change in the tint when a projected image is switched.

(Appendix 5) The projection method described in any one of Appendices 1 to 4, wherein the second sensor is a sensor different from the first sensor.

According to Appendix 5, by disposing a sensor suitable for a change in the first display surface desired to be detected, it is possible to switch a correction value and a corrected image only in a specific situation and it is possible to suppress deterioration in the image quality of a projected image. For example, by using an acceleration sensor as the second sensor, it is possible to take measures such as not switching the correction value when it is successfully determined that the projector or the first display surface has returned to an original position because of light shaking or the like.

(Appendix 6) The projection method described in Appendix 5, wherein the second sensor is disposed on the first display surface.

According to Appendix 6, without reacting to an object interrupting between the first display surface and the projector, the correction value is changed only when the first display surface itself changes. As a result, it is possible to reduce discomfort felt by the user because the correction value is frequently converted by the interrupting object.

(Appendix 7) A projection system including: a first sensor configured to measure a reflection characteristic of a color component of reflected light from a first display surface having a first color; a second sensor configured to detect a change in the first display surface; a projector configured to project an image onto the first display surface; and one or a plurality of processors configured to control the projector, wherein the one or the plurality of processors executes: measuring, with the first sensor, the reflection characteristic of the color component of the reflected light from the first display surface; generating, based on the reflection characteristic, a plurality of first correction values that are a plurality of correction values for bringing a color of a plurality of points in the image projected onto the first display surface to a color in a case in which the image is projected onto a second display surface having a second color; generating first corrected image data by performing color correction for input image data based on the plurality of first correction values; projecting a first corrected image based on the first corrected image data onto the first display surface; when detecting the change in the first display surface with the second sensor, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface without performing the color correction; and projecting a second corrected image based on the second corrected image data onto the first display surface.

According to Appendix 7, even if a relative positional relationship between the first corrected image projected first and the first display surface changes, it is possible to prevent the quality of the second corrected image projected onto the first display surface instead of the first corrected image from deteriorating more than the quality of the first corrected image.

(Appendix 8) A non-transitory computer-readable storage medium storing a program for causing a computer to execute: measuring, with a first sensor, a reflection characteristic of a color component of reflected light from a first display surface having a first color; generating, based on the reflection characteristic, a plurality of first correction values that are a plurality of correction values for bringing a color of a plurality of points in an image projected onto the first display surface to a color in a case in which the image is projected onto a second display surface having a second color; generating first corrected image data by performing color correction for input image data based on the plurality of first correction values; projecting a first corrected image based on the first corrected image data onto the first display surface; when detecting a change in the first display surface with a second sensor, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface without performing the color correction; and projecting a second corrected image based on the second corrected image data onto the first display surface.

According to Appendix 8, even if a relative positional relationship between the first corrected image projected first and the first display surface changes, it is possible to prevent the quality of the second corrected image projected onto the first display surface instead of the first corrected image from deteriorating more than the quality of the first corrected image.

What is claimed is:

1. A projection method comprising:
measuring, with a first sensor, a reflection characteristic of a color component of reflected light from a first display surface having a first color;
generating, based on the reflection characteristic, a plurality of first correction values that are a plurality of correction values for bringing a color of a plurality of points in an image projected onto the first display surface to a color in a case in which the image is projected onto a second display surface having a second color;
generating first corrected image data by performing color correction for input image data based on the plurality of first correction values;
projecting a first corrected image based on the first corrected image data onto the first display surface;
when detecting a change in the first display surface with a second sensor, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface without performing the color correction; and
projecting a second corrected image based on the second corrected image data onto the first display surface.

2. The projection method according to claim 1, wherein the correction values included in the plurality of second correction values are zero.

3. The projection method according to claim 1, wherein the correction values included in the plurality of second correction values are an average value of the plurality of first correction values.

4. The projection method according to claim 1, further comprising, before projecting the second corrected image onto the first display surface:
generating third corrected image data by performing the color correction for the input image data based on the plurality of third correction values obtained by changing at least a part of the plurality of first correction values to the correction values for bringing the color of the plurality of points close to the color of the image projected onto the first display surface without performing the color correction; and
projecting a third corrected image based on the third corrected image data onto the first display surface, wherein
the second corrected image includes a portion closer to the color of the image projected onto the first display surface without performing the color correction than the third corrected image.

5. The projection method according to claim 1, wherein the second sensor is a sensor different from the first sensor.

6. The projection method according to claim 5, wherein the second sensor is disposed on the first display surface.

7. A projection system comprising:
a first sensor configured to measure a reflection characteristic of a color component of reflected light from a first display surface having a first color;
a second sensor configured to detect a change in the first display surface;
a projector configured to project an image onto the first display surface; and
one or a plurality of processors configured to control the projector, wherein
the one or the plurality of processors execute:
measuring, with the first sensor, the reflection characteristic of the color component of the reflected light from the first display surface;
generating, based on the reflection characteristic, a plurality of first correction values that are a plurality of correction values for bringing a color of a plurality of points in the image projected onto the first display surface to a color in a case in which the image is projected onto a second display surface having a second color;
generating first corrected image data by performing color correction for input image data based on the plurality of first correction values;
projecting a first corrected image based on the first corrected image data onto the first display surface;
when detecting the change in the first display surface with the second sensor, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface without performing the color correction; and
projecting a second corrected image based on the second corrected image data onto the first display surface.

8. A non-transitory computer-readable storage medium storing a program for causing a computer to execute:
measuring, with a first sensor, a reflection characteristic of a color component of reflected light from a first display surface having a first color;
generating, based on the reflection characteristic, a plurality of first correction values that are a plurality of correction values for bringing a color of a plurality of points in an image projected onto the first display surface to a color in a case in which the image is projected onto a second display surface having a second color;
generating first corrected image data by performing color correction for input image data based on the plurality of first correction values;
projecting a first corrected image based on the first corrected image data onto the first display surface;
when detecting a change in the first display surface with a second sensor, generating second corrected image data by performing the color correction for the input image data based on a plurality of second correction values obtained by changing at least a part of the plurality of first correction values to correction values for returning the color of the plurality of points to or bringing the color of the plurality of points to a color of the image projected onto the first display surface without performing the color correction; and
projecting a second corrected image based on the second corrected image data onto the first display surface.
